(19) United States
(12) Patent Application Publication
(10) Pub. No.: US 2006/0010075 A1
(43) Pub. Date: Jan. 12, 2006

(54) Technique for facilitating resale of digital content over a computer network

(76) Inventor: Dean Wolf, Oakland, CA (US)

Correspondence Address: Dean Wolf, 5442 Boyd Ave, Oakland, CA, 94618, US

(21) Appl. No.: 11/177,792

(22) Filed: Jul. 7, 2005

Related U.S. Application Data
(60) Provisional application No. 60/586,322, filed on Jul. 8, 2004.

(51) Int. Cl. G06F 17/60

(52) U.S. Cl. 705/57

(57) ABSTRACT

A technique is described for facilitating resale of digital content purchased via an electronic commerce transaction.

### RELATED APPLICATION DATA

The present application claims priority under 35 U.S.C. § 119 to U.S. Provisional Application Ser. No. 60/586,322 (Docket No. DWXXP001P), naming Dean Wolf as inventor, and filed Jul. 7, 2004, the entirety of which is incorporated herein by reference in its entirety for all purposes.

### BACKGROUND OF THE INVENTION

The present invention relates generally to electronic commerce, and more particularly to a technique for facilitating resale of digital content over a computer network.

Over the past decade there has been a steady increase in consumer electronic commerce transactions performed over global computer networks such as the Internet. This increase in electronic commerce transactions has dramatically affected the type of products and/or services available to both the consumer and business markets. For example, copyrighted digital works such as computer software programs, digital music, digital video, etc., are now available for purchase on-line in digital form. Conventionally, such copyrighted works were sold exclusively via digital media such as computer software CDs, compact discs, and DVDs. Traditionally, under the well established common law doctrine known as the “first sale” doctrine, the owner of a lawful copy of a work is allowed to sell that copy without permission of the copyright owner. More recently, however, copyright owners and other organizations have lobbied for changes in the laws governing the use and sale of copyrighted works which include digital content. Presently, many of the laws governing the use and sale of copyrighted digital content are addressed in the Digital Millennium Copyright Act (DCMA).

One of the major issues concerning digital content is the relative ease in which the digital content may be copied and distributed over the Internet. For example, the growing popularity of peer-to-peer file sharing networks such as Kazaa allows users from all over the world to share copies of many types of copyrighted digital content, including software programs, digital movies, and digital music. This has resulted in a proliferation of piracy and other copyright law violations. Copyright owners and other organizations such as motion picture and record companies have responded by attempting to restrict the use and/or sale of copyrighted digital content, particularly with respect to digital content which is purchased on-line in digital form. However, despite such efforts, the increasing availability of free digital content (over peer-to-peer file sharing networks such as Kazaa) has created a perception in the mind of the consumer, particularly with respect to consumers of the younger generation, that digital content (such as music files) should be freely distributed and accessible. Such perceptions and activities significantly hamper profitability of electronic commerce transactions relating to on-line sales of copyrighted digital content such as, for example, digital music.

In response, on-line music stores such as iTunes.com and Napster.com have attempted to placate consumer demands for unrestricted use of purchased digital content, for example, by selling encoded music files that are able to be copied and played only on a limited number of authorized client devices. For example, a consumer is able to purchase a desired music file (song) in digital format from iTunes.com. The purchased song is encoded using an AAC format and includes embedded information relating to the identity of the purchaser (owner), which is used to prevent other consumers from playing the music file unless specifically authorized. Although the purchasing consumer is allowed to make copies of the purchased music file, the song is only allowed to be played on at most five computers which have been authorized for playing music purchased by that particular consumer.

One issue associated with on-line music sales such as those described above is that there is no provision for allowing a consumer who purchased a particular song to sell or otherwise transfer ownership of the purchased song. The consumer is not provided with any mechanism by which he or she is able to change the ownership information associated with that song. Similar restrictions are currently being developed for other types of digital content. While such an approach may be acceptable to the copyright owners, it may be less acceptable to consumers who believe they have the right to sell a legally purchased copy of a copyrighted work to a third party without consent of the copyright owner. Accordingly, it will be appreciated that there exists a need to facilitate resale of digital content over a computer network.

### SUMMARY OF THE INVENTION

Various aspects of the present invention are directed to different methods, systems, and computer program products for facilitating resale of digital content purchased via an electronic commerce transaction.

According to one embodiment, a first portion of information is received relating to a sale of a first copy of a digital file to a first customer. The digital file includes digital content. The first portion of information includes ownership information which identifies the first customer as the owner of the first copy. A first database record relating to the first copy is created. The first database record includes ownership information which identifies the first customer as the owner of the first copy. A second portion of information relating to a resale of the first copy to a second customer is received. The second portion of information includes ownership information which identifies the second customer as the owner of the first copy. The first database record may then be modified to include ownership information which identifies the second customer as the owner of the first copy.

According to another embodiment, a request is received from a first customer to purchase a copy of a digital file which includes digital content. A first copy of the requested digital file is generated. The first copy includes ownership information identifying the first customer as the owner of the first copy. A request received to transfer ownership of the first copy to a second customer. A second copy of the requested digital file is generated. The second copy includes ownership information identifying the second customer as the owner of the second copy.

In yet another embodiment, a request is received from a first customer to purchase a copy of a digital file which includes digital content. A first copy of the requested digital file is generated. The first copy includes ownership information identifying the first customer as the owner of the first copy. A request received to transfer ownership of the first copy to a second customer. The first copy of the requested digital file is modified, wherein the modified first copy includes ownership information identifying the second customer as the owner of the first copy.

### BRIEF DESCRIPTION OF THE DRAWINGS

FIG. 1 shows an example of a computer network 100 which may be used for implementing various aspects of the present invention in accordance with a specific embodiment.

FIGS. 2-4 of the present application illustrate examples of different procedures which may be implemented in facilitating electronic commerce transactions relating to the sale and/or resale of the copies of copyrighted digital content.

FIG. 5 illustrates a specific embodiment of a network device 60 suitable for implementing the on-line digital content resale techniques of the present invention.

### DETAILED DESCRIPTION OF THE PREFERRED EMBODIMENTS

According to various embodiments of the present invention, a technique is described for facilitating resale of digital content over a computer network. As explained in greater detail below, the technique of the present invention attempts to address a conflict between copyright owners and consumers regarding the use and sale of purchased, copyrighted digital content (such as, for example, computer software, digital music, digital videos, etc.) by proposing a solution which preserves the “first sale” doctrine for consumers and which also benefits the copyright owner. For purposes of simplification, and in order to avoid confusion, different embodiments of the present invention will be described by way of example with reference to on-line music sales. However, it will be appreciated that the technique of the present invention described herein may also be applied to on-line sales of other types of digital content such as, for example, computer software, digital videos, digital photographs, digital audio books, digital e-books, etc.

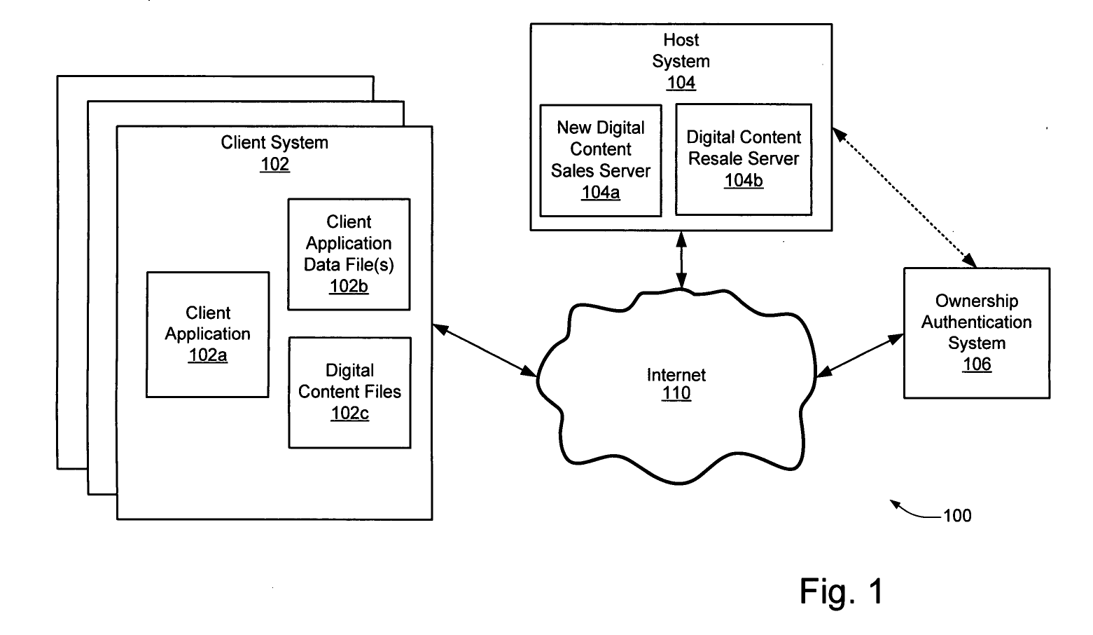

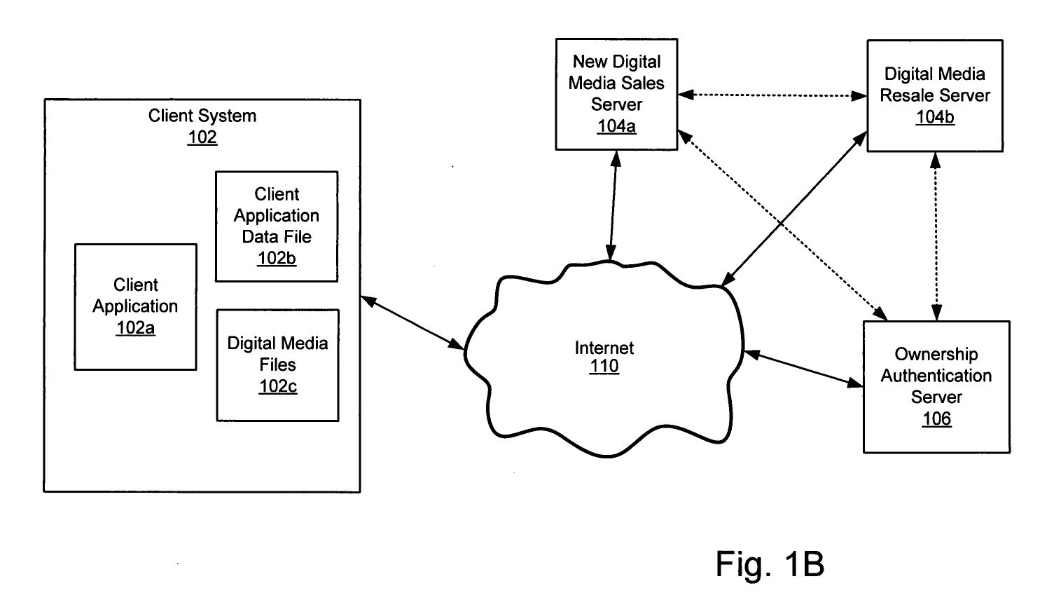

FIG. 1 shows an example of a computer network 100 which may be used for implementing various aspects of the present invention in accordance with a specific embodiment. The network 100 of FIG. 1 includes at least one client system 102, at least one host system 104, and at least one ownership authentication system 106. Each of these systems may be configured or designed to communicate with each other via a global computer network such as, for example, the Internet 110. According to a specific embodiment, client system 102 may include a client application 102a, at least one client application data file 102b, and, if present, one or more files 102c which include copyrighted digital content such as, for example, digital music files. One example of a client system may correspond to a personal computer system which is configured to access the Internet 110. In this example, the client application 102a may be configured or designed to include functionality similar to the client-side iTunes application, available from Apple Computer, Inc. of Cupertino, Calif. Such functionality may include, for example, content and media management functionality, playing and recording functionality, functionality for performing electronic commerce transactions relating to purchasing and/or resale of digital content, etc.

According to a specific embodiment, host system 104 may include at least one new digital content sales server 104a, and at least one digital content resale server 104b. In an alternate embodiment shown in FIG. 1B, the new digital content sales server 104a and the digital content resale server 104b may reside in different systems of the computer network. In one example, the new digital content sales server 104a may be configured or designed to have functionality similar to the server(s) which are used for hosting the on-line iTunes music store. Such functionality may include, for example, content and media management functionality, content streaming functionality, playing and recording functionality, encoding and encryption functionality, functionality for performing electronic commerce transactions relating to purchasing and/or resale of digital content, etc.

According to a specific embodiment, the ownership authentication system 106 may be configured or designed to process and store information relating to electronic sales of copyrighted digital content. For example, in one implementation, the ownership authentication system 106 may be configured or designed to maintain an information database relating to legally purchased copies of digital music files, including the current registered owner of each purchased copy.

As illustrated in FIG. 1A, communication between the various systems 102, 104, 106 may be achieved via direct connection and/or via a wide area network such as the Internet.

According to different embodiments of the present invention, the various systems illustrated in the network of FIG. 1A may be configured or designed to include at least a portion of the functionality incorporated into conventional on-line digital content purchasing solutions such as, for example, iTunes or Napster. At least a portion of such functionality is described, for example, in U.S. Patent Application Publication No. US20040123103, entitled “METHOD FOR REDIRECTING OF KERNEL DATA PATH FOR CONTROLLING RECORDING OF MEDIA”; U.S. Patent Application Publication No. U.S. 20040117663, entitled “METHOD FOR AUTHENTICATION OF DIGITAL CONTENT USED OR ACCESSED WITH SECONDARY DEVICES TO REDUCE UNAUTHORIZED USE OR DISTRIBUTION”; U.S. Patent Application Publication No. U.S. 20040117644, entitled “METHOD FOR REDUCING UNAUTHORIZED USE OF SOFTWARE/DIGITAL CONTENT INCLUDING SELF-ACTIVATING/SELF-AUTHENTICATING SOFTWARE/DIGITAL CONTENT”; U.S. Patent Application Publication No. U.S. 20040117631, entitled “METHOD FOR DIGITAL RIGHTS MANAGEMENT INCLUDING USER/PUBLISHER CONNECTIVITY INTERFACE”; U.S. Patent Application Publication No. U.S. 20040107368, entitled “METHOD FOR DIGITAL RIGHTS MANAGEMENT INCLUDING SELF ACTIVATING/SELF AUTHENTICATION SOFTWARE”; U.S. Patent Application Publication No. U.S. 20040103300, entitled “METHOD OF CONTROLLING RECORDING OF MEDIA”; U.S. Patent Application Publication No. U.S. 20040103297, entitled “CONTROLLING INTERACTION OF DELIVERABLE ELECTRONIC MEDIA”; U.S. Patent Application Publication No. U.S. 20040098533, entitled “USE OF A MEDIA CACHE FOR SUBSEQUENT COPYING ACCELERATION”; U.S. Patent Application Publication No. U.S. 20040093208, entitled “AUDIO CODING METHOD AND APPARATUS”; U.S. Pat. No. 6,738,744, entitled “WATERMARK DETECTION VIA CARDINALITY-SCALED CORRELATION”; U.S. Pat. No. 6,728,729, entitled “ACCESSING MEDIA ACROSS NETWORKS”; U.S. Patent Application Publication No. U.S. 20040034539, entitled “ORIGINAL WAY TO SELL NEW SOUND RECORDINGS”; U.S. Patent Application Publication No. U.S. 20040030900, entitled “UNDETECTABLE WATERMARKING TECHNIQUE FOR AUDIO MEDIA”; U.S. Patent Application Publication No. U.S. 20030221127, entitled “SYSTEM AND METHOD FOR PROVIDING GLOBAL MEDIA CONTENT DELIVERY”; U.S. Patent Application Publication No. U.S. 20030204738, entitled “SYSTEM AND METHOD FOR SECURE DISTRIBUTION OF DIGITAL CONTENT VIA A NETWORK”; U.S. Patent Application Publication No. U.S. 20030188152, entitled “SECURE IP BASED STREAMING IN A FORMAT INDEPENDENT MANNER”; U.S. Patent Application Publication No. U.S. 20030172033, entitled “METHOD AND SYSTEM FOR PROVIDING LOCATION-OBSCURED MEDIA DELIVERY”; U.S. Patent Application Publication No. U.S. 20030167318, entitled “INTELLIGENT SYNCHRONIZATION OF MEDIA PLAYER WITH HOST COMPUTER”; U.S. Patent Application Publication No. U.S. 20030154132, entitled “DISTRIBUTION SYSTEM, TERMINAL APPARATUS, DISTRIBUTION METHOD, PROGRAM AND RECORDING MEDIUM”; U.S. Patent Application Publication No. U.S. 20030120549, entitled “METHOD AND APPARATUS FOR OFFERING DIGITAL CONTENT FOR SALE OVER A COMMUNICATIONS NETWORK”; U.S. Patent Application Publication No. U.S. 20030079038, entitled “INTELLIGENT INTERACTION BETWEEN MEDIA PLAYER AND HOST COMPUTER”; U.S. Patent Application Publication No. U.S. 20020147683, entitled “METHOD FOR PURCHASING WEB BASED DIGITAL MEDIA”; each of which is incorporated herein by reference in its entirety for all purposes.

In accordance with different embodiments of the present invention, the various systems illustrated in FIG. 1A may be configured or designed to facilitate electronic commerce transactions relating to the sale of the new copies of copyrighted digital content as well as the resale of previously purchased copies of copyrighted digital content. As explained in greater detail below, a user of client system 102 may purchase new copies of copyrighted digital content from new digital content sales server 104a. If the user wishes to sell a legally purchased copy of copyrighted digital content, the user may sell the legally purchased copy to another consumer via digital content resale server 104b. In addition, the user may also purchase previously purchased copies of copyrighted digital content via digital content resale server 104b.

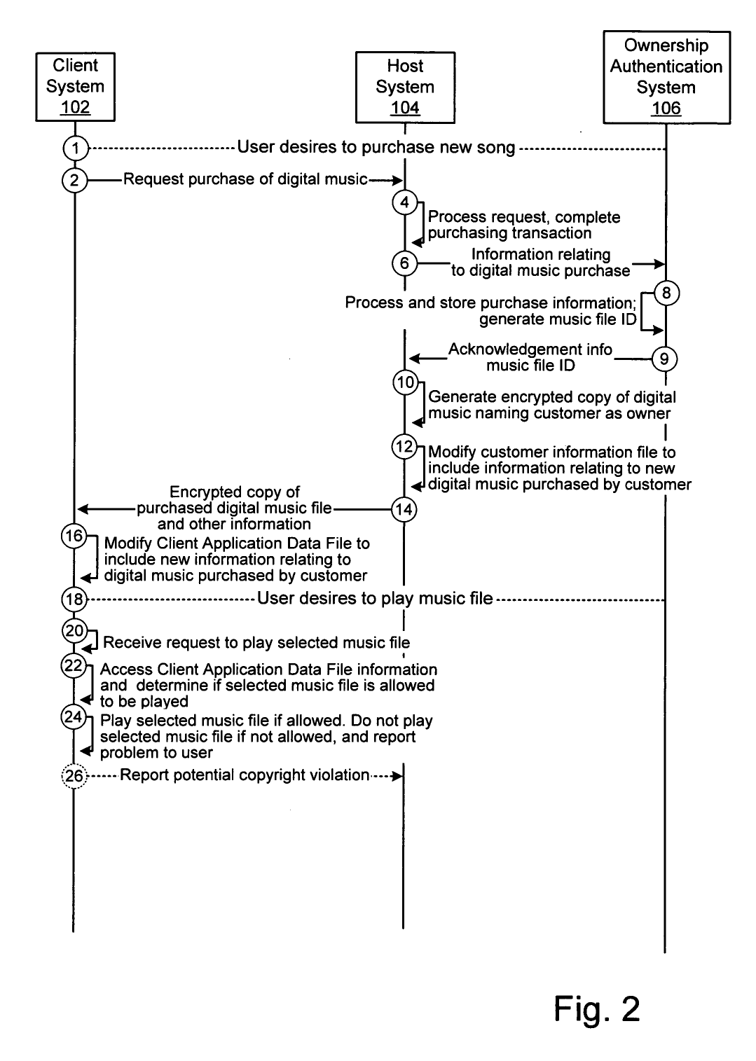

FIGS. 2-4 of the present application illustrate examples of different procedures which may be implemented in facilitating electronic commerce transactions relating to the sale and/or resale of the copies of copyrighted digital content. For purposes of illustration, the procedures described in FIGS. 2-4 relate to examples of on-line sales and resales of digital music files. However, it will be appreciated that the technique of the present invention described herein may also be applied to on-line sales of other types of digital content such as, for example, computer software, digital videos, digital photographs, digital audio books, digital e-books, etc.

FIG. 2 shows a flow diagram of various procedures which may take place between the client system, host system, and ownership authentication system for enabling the on-line purchase and playing of a new copy of a digital music file. In this example, it is assumed that a user of client system 102 has received a unique customer ID from the host system 104 which may be used for allowing the user to purchase copies of digital music files which are offered for sale by the host system. For example, in a specific implementation where the host system corresponds to the on-line iTunes music store, the customer ID is the customer's e-mail address. Before any purchases can be made, the customer first signs on to the iTunes host server by providing his or her customer ID and password.

In the example of FIG. 2, it is assumed at (1) that the customer desires to purchase a new copy of a selected song. According to a specific implementation, the customer is able to submit (2) the request to purchase a new copy of a selected song using the client application 102a (e.g., client-side iTunes application). In one embodiment, the request may include information such as, for example, the customer ID, the IP address of the client system, a client system ID which may be used to uniquely identify client system 102, song ID corresponding to the selected song for purchase, etc. Upon receiving the request, the host system 104 processes (4) the request, for example, by charging the cost of the song to the customer's credit card account. According to a specific embodiment of the present invention, the customer may be offered a two-tier pricing structure for purchasing the selected song, wherein the customer is offered the choice to purchase the selected song without resale rights at a lower price, or to purchase the selected song with resale rights at a higher price. In an alternate embodiment, the customer is given the opportunity to pay an additional premium to purchase resale rights for the selected song.

Once the purchasing transaction has been completed, the host system may then send (6) information relating to the purchase of the digital music file may to the ownership authentication system 106. In one implementation, such information may include, for example, the song ID, the customer ID, information relating to the system which sold the song (e.g., host system ID), time of purchase, date of purchase, amount of purchase, etc. The ownership authentication system may then process (8) and store at least a portion of the digital music file purchase information, in a local database and/or a centralized database. Additionally, according to one implementation, the ownership authentication system may also generate a music file ID which may be used for uniquely identifying the purchased copy of the selected song. According to different implementations, the music file ID may be generated using a variety of different techniques commonly known to one having ordinary skill in the art. For example, portions of information relating to the digital music file purchase may be hashed in order to generate the unique music file ID corresponding to that particular copy of the song which has been sold to the consumer. According to different implementations, a variety of standardized hashing algorithms may be used such as, for example, an MD5 hashing algorithm. Alternatively, the music file ID may be generated using other information, or may be randomly generated.

One benefit of the music file ID feature is that it enables a database may be maintained of information relating to all or selected digital music files which have been legitimately purchased on-line in accordance with copyright laws. Additionally, the music file ID also provides additional benefits such as, for example, enabling the ability to track subsequent resales of digital music files, enabling verification of authenticity and/or legitimacy of selected digital music files, etc. For example, according to one implementation, when a new song is purchased on-line by a consumer, a unique music file ID may be generated and associated with that copy of the song which has been purchased by the consumer. If the consumer subsequently desires to sell his legitimately purchased copy of the song, a prospective purchaser may easily verify the legitimacy of the song copy, for example, by accessing the ownership authentication system and verifying that the song copy offered for sale corresponds to the music file ID and that the owner of the song corresponds to the seller.

As shown at (9) the ownership authentication system may transmit acknowledgment information back to host system 104. In one implementation, the acknowledgment information may include the music file ID to be associated with that particular song purchase. The host system may then generate (10) an encrypted and/or encoded copy of a digital music file corresponding to the purchased song. According to a specific implementation, the generated music file may include embedded information (e.g., metadata) which includes, for example, the identity of the owner of the digital music file (i.e., the purchasing customer); the associated music file ID), information relating to restrictions on use, sale, or transfer; and/or other information. According to at least one implementation, encryption of the digital music file may be performed using a unique encryption key associated with that particular customer ID. In at least one embodiment, each customer ID may have associated therewith a unique encryption and/or decryption key which may be used by the client application 102a or other applications for playing digital music files associated with that particular customer ID. According to different implementations, a variety of standardized encryption algorithms may be used such as, for example, an AES encryption algorithm.

According to alternate embodiments of the present invention (not shown), the generation of the music file ID may be performed by the host system 104, and transmitted to the ownership authentication system 106 as part of the information relating to the digital music purchase. In a different embodiment, the features relating to the above-described music file ID may be omitted.

According to at least one embodiment, the host system 104 may maintain an information database relating to customer transactions. In the example of FIG. 2, the host system may modify (12) its database to include information relating to the new digital music purchased by the customer identified by the customer ID. In this way, the host system is able to keep track of all songs which have been legitimately purchased by the customer from the host system's on-line music store.

As shown at (14), the host system 104 transfers (e.g., downloads) the encrypted copy of the purchased digital music file and other information to the client system 102. According to one embodiment, such other information may include, for example, information relating to the digital music purchased by the customer such as, for example, song ID; music file ID; customer ID; encryption/decryption key(s); restrictions on sale, transfer, duplication; etc. Once the transfer is complete, the client system may modify (16) one or more client application data file(s) to include at least a portion of additional information received. For example, in one implementation, a client application data file may include information relating to all songs which have been legitimately purchased by the customer from the host system and/or other systems. When the customer purchases a new song, information relating to the new song purchase may be stored in the client application data file. If the customer subsequently sells or otherwise transfers a legitimately purchased song to another party, the client application data file may be modified to record this activity. The information stored in the client application data file may then be accessed by the client application 102a in order, for example, to detect any possible copyright law violations. This is explained in greater detail below.

According to an alternate embodiment (not shown), creation of the encrypted copy of the purchased digital music file may be created on the fly at host system 104, and streamed to client system 102, whereupon client system 102 compiles the streamed information into an appropriate format for storage and playback on the client system.

Referring to FIG. 2, at (18) it is assumed that the user (or customer) desires to play a particular music file stored on the client system. In one embodiment, the client application 102a may be configured or designed to play selected music files on the client system. When the client application 102a receives (20) a request to play a selected music file, the client application may access (22) information from one or more of the client application data files in order to determine whether the selected music file is allowed to be played on the client system. In this way, the client system is able to detect possible copyright law violations. This concept may be illustrated by the following examples.

In the first example, it is assumed that the customer wishes to play the newly purchased song using the client application 102a. When the client application checks the client application data file information, it will see that the customer has purchased a legitimate copy of the song that has been requested to be played. In one embodiment, the client application may verify that the music file ID in the client application data file matches the music file ID of the song that has been requested to be played. In a different implementation, the client application may check the client application data file to determine whether the customer has purchased the song ID associated with the song that has been requested to be played. Assuming that there are no problems detected by the client application, the client application will proceed to play (24) the selected music file.

In a second example, it is assumed that the customer originally purchased a song from the on-line music store, made a duplicate copy of the digital music file of that song on the client system, and then sold the original copy of the digital music file to another party. As described previously, the client application may be configured or designed to modify the client application data file to reflect a sale of a purchased song. Accordingly, in at least one implementation, when the customer sells the digital music file of the song to another party, the client application will modify the client application data file to reflect that the customer no longer owns a legitimate copy of the song which has been sold. If the customer then attempts to play the duplicate copy of the digital music file, the client application may determine, using the client application data file information, that the selected digital music file is a possible illegitimate copy of the digital music file which has been sold to another party, which may indicate a possible copyright law violations. In response, the client application of may perform a variety of operations such as, for example, refusing to play the selected song, notifying the customer of a potential copyright law violations, reporting (26) a potential copyright law violation to the host system, etc.

It will be appreciated that there are other mechanisms which may be implemented on the client system 102 in order to prevent unauthorized use and/or play of digital music files. Such mechanisms may be utilized in addition to those described above. For example, it is possible for a client-server system to utilize an encrypted authorization/deauthorization process for preventing unauthorized use and/or play of digital music files. In order to authorize a particular computer for playing digital music files associated with a particular customer ID, the client application generates a unique client system ID for the computer system. The unique client system ID is then sent to the server system along with the client ID for recordkeeping and verification purposes. The server may then attached the unique client system ID to the customer ID's account and respond by providing the client application with the customer ID's decryption key which may be used for decrypting and playing digital music files associated with that customer ID.

It will be appreciated that, according to at least one embodiment, even though the client system 102 may be authorized to play digital music files associated with the customer ID, the client application 102a may be configured or designed to not permit a selected song to be played (even if the song has been encrypted using the customer ID's encryption key) if it is determined that there are possible copyright law violations associated with the selected song.

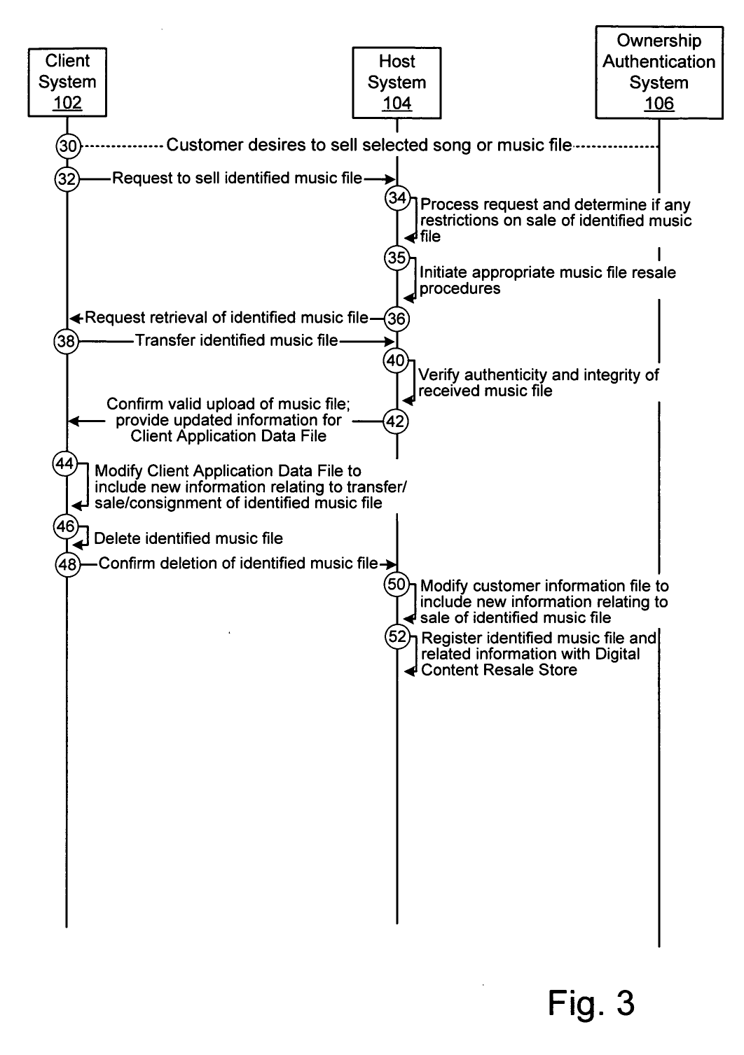

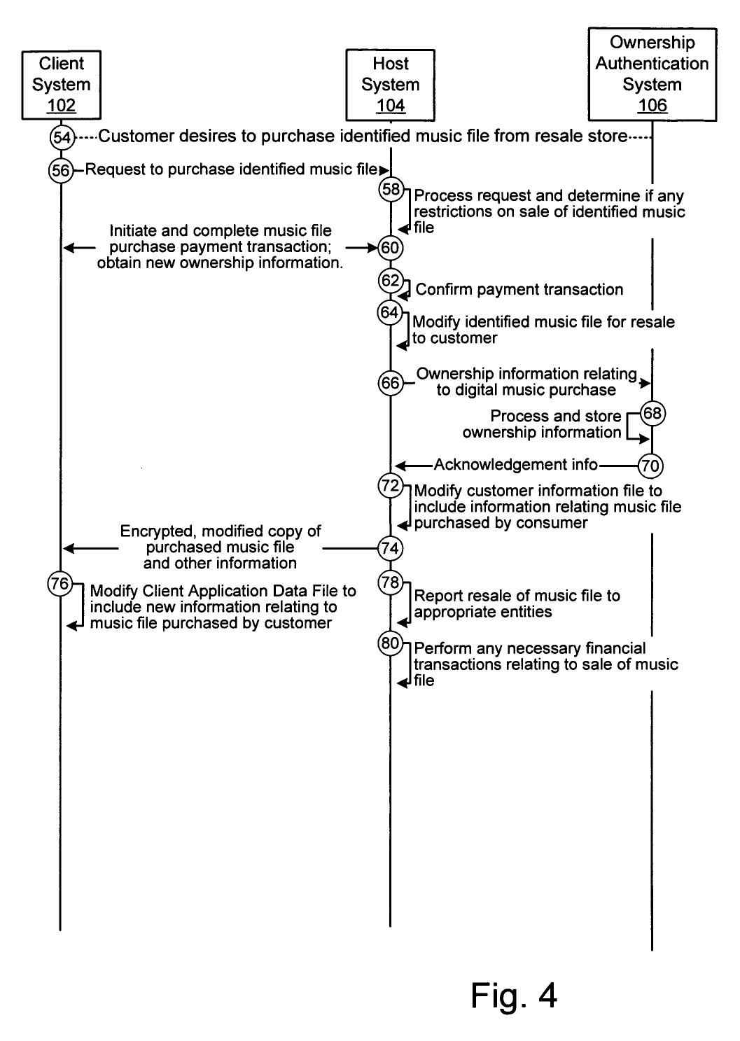

FIGS. 3-4 show flow diagrams of various procedures which may take place between the client system, host system, and ownership authentication system for enabling customers to sell their previously purchased songs. In the example of FIG. 3, it is assumed at (30) that a customer desires to sell a previously purchased song or music file. According to a specific implementation, the customer is able to submit (32) the request to sell the selected music file copy using the client application 102a. In one embodiment, the request may include information such as, for example, the customer ID, the IP address of the client system, a client system ID which may be used to uniquely identify client system 102, song ID corresponding to the selected song for resale, music file ID, desired sales price, etc. Upon receiving the request, the host system 104 processes (34) the request and determines whether there are any restrictions on the sale of the identified song copy.

It will be appreciated that a significant impediment to the success of on-line digital music resale stores is the potential threat such stores pose to the profits of the copyright owners such as the record companies. This threat is due, in part, to the nature of copyrighted digital content which is sold via electronic commerce. More specifically, goods which are resold in non-electronic commerce are typically classified as “used” goods. Typically, the market value of a product in “used” condition is lower than the market value of the same product in “new” condition. This is generally due to the fact that the qualitative condition of the “new” product is perceived as being better than the qualitative condition of the “used” product. For example, used CDs typically sell at a lower value compared to the same CDs in new condition. Used books typically sell at a lower value compared to the same the books in new condition. However, with respect to purely digital content such as digital music files, the qualitative condition of a “new” copy of a particular digital music file is perceived to be indistinguishable from the qualitative condition of a “used” copy of the same digital music file (i.e. a digital music file which has been previously purchased and then resold to another customer). Accordingly, it may be argued that a consumer would not be motivated to buy a new copy of a particular song at a higher purchase price when that same song can be purchased at a cheaper price in the on-line resale market place. As a result, it may also be argued that the overall effect of allowing resale of digital music would be the lowering of the price point of new copies of digital music files to match the prices of resold digital music files since there would be no incentive for the consumer to pay a higher price for the new copy of the digital music file. Accordingly, it is of no surprise that record companies vehemently oppose the introduction of on line digital music resale stores.

In order to overcome this obstacle, the present inventive entity recognizes the desirability of solutions which offer reasonable safeguards to the record companies for helping to preserve their potential profits. One such solution relates to imposing rules and/or restrictions on the resale of digital music files. Another such solution relates to modifying resold digital music files in a manner which results in a degradation of the market value of such files as compared to their new digital music file counterparts. These and other such solutions are described in greater detail below.

According to at least one embodiment of the present invention a variety of different rules and/or restrictions may be implemented in order to restrict the resale of previously purchased songs. Such rules/restrictions may be triggered, for example, upon the occurrence of a variety of different conditions. Examples of at least some of the different conditions which may trigger restrictions on the resale of an identified song copy (i.e. an identified digital music file) are described below.
1. The identified song copy is already being offered for resale or has already been sold to another customer.
2. There is no purchase record of the identified song copy associated with the seller's customer id.
3. The identified song copy does not include resale rights. According to one embodiment, information relating to the resale rights of the identified song copy may be included in the metadata portion of the digital music file corresponding to that song copy. In other embodiments, information relating to the resale rights of the identified song copy may be obtained from information stored at the host system 104 and/or information stored at the ownership authentication system 106.
4. The resale rights associated with the identified song copy have been used up or expired. According to one embodiment, resale rights of the identified signed copy may only be allowed during a designated time period. When the time period expires, the resale rights also expire. In an alternate embodiment, each digital music file which is sold may have a respective resale parameter associated with it which represents the maximum number of resales permitted for that particular digital music file. For example, a newly purchased digital music file may be allowed to be resold a maximum of 5 times. Each time that digital music file is resold to another customer, the resale parameter associated with that digital music file is decremented by one. When the resale parameter reaches the value of zero, the digital music file is no longer permitted to be resold. In one implementation, the resale parameter information may be included in the metadata portion of the digital music file. In other implementations, information relating to the resale parameter associated with a particular digital music file may be obtained from information stored at the host system 104 and/or information stored at the ownership authentication system 106. One of the benefits of this feature is that it provides an inherent mechanism for degrading the market value of resold digital music files (as compared to their new digital music file counterparts) since, presumably, a customer would pay less for a digital music file which is only able to be resold one more time than he or she would pay for a digital music file which is able to be resold up to 5 times.
5. The identified song copy has been flagged as possibly violating copyright laws. As described previously, the technique of the present invention provides various mechanisms for detecting digital music files which may have possible copyright law violations.
6. The identified song copy has been altered or modified, without authorization, from its original version as sold.
7. Resale of the identified song copy would violate resale timing restrictions. According to different embodiments, different types of timing restrictions may be implemented to control or restrict resale of selected digital music files. For example, one such timing restriction may stipulate that a purchased song copy is not allowed to be resold within a first specified time period (e.g., 1 day, 1 month, 1 year, etc.) from the date that the purchase was made. This feature may help to discourage customers from purchasing songs, making illegal copies of those songs, and then attempting to resell the purchased songs while retaining the illegal copies. Another such timing restriction may stipulate that a purchased song copy is not allowed to be resold within a second specified time period (e.g., 1 week, 1 month, 6 months, 1 year, etc.) from the date that the song was first released in downloadable digital format. This feature may be useful in helping copyright owners and/or record companies to achieve adequate sales of new a song release before customers are permitted to sell their copies of the song via the on-line digital music resale market place.
8. Resale of the identified song copy would violate maximum authorized number of song copies authorized for resale. According to at least one embodiment, restrictions may be placed upon the maximum number of copies of a particular song which are allowed to be resold. In one embodiment, the maximum number may represent a maximum number of song copies which are simultaneously offered for resale at any one time. In another embodiment the maximum number may represent a maximum cumulative number of song copies allowed to be sold during a specified time period.
9. Resale of the identified song copy would violate pricing restrictions. According to at least one embodiment, pricing restrictions such as, for example, a minimum price restriction, may be established for the resale of all or selected digital music files.
10. Resale of the identified song copy would violate copyright laws and/or licensing restrictions.
11. Existence of possible duplicate copy of identified song copy detected. According to at least one embodiment, resale of the identified signed copy may be restricted if it is determined that a duplicate or backup copy has been made of the identified digital music file. For example, the client application 102a may be configured or designed to permit a customer to burn an audio CD of purchased digital music files. In one implementation, the client application may keep track of this information, and pass this information on to the host system 104. The host system may store this information and/or pass this information on to the ownership authentication system 106. This information may then be used to prevent the customer from selling a purchased digital music file which has already been burned onto an audio CD.

The examples above illustrate some possible conditions which may trigger restrictions on the resale of the identified song copy. However, it will be appreciated that there are a variety of other types of conditions which may trigger restrictions on the resale of a particular song copy. In at least one embodiment, such other conditions may generally relate to conditions imposed by copyright owners (e.g. record companies) to help encourage sales of new song copies.

Returning to FIG. 3, if it is determined that there are no restrictions on resale of the identified music file, the host system may then initiate (35) appropriate music file resale procedures.

According to different embodiments of the present invention, a variety of different techniques may be used for effecting electronic commerce transactions involving the resale of digital music files. For example, in one implementation, a consignment technique may be utilized wherein customers may offer their purchased digital music files for sale on an on-line consignment store. In one embodiment, the on-line consignment store may be hosted on the digital content resale server 104b. A customer desiring to sell a purchased digital music file transfers the digital music file to the on-line consignment store to be sold “on consignment.” According to at least one implementation, the client application 102a may be configured or designed to facilitate the transfer of the digital music file from the client system 102 to the host system 104. The sale price of the digital music file may be specified by the customer, the on-line consignment store, or may be set according to predetermined criteria. The seller is paid after the digital music file is purchased by another customer. In one implementation, the on-line consignment store receives a commission for the sale. Additionally, in at least one implementation, the copyright owner of the digital music file may also receive a share of proceeds from the sale.

In an alternate implementation, an auction technique may be used to allow customers to offer their purchased digital music files for resale. For example, a customer desiring to sell a purchased digital music file may place the digital music file up for auction. In one embodiment, the on-line auction site may be hosted on the digital content resale server 104b. Alternatively, other auction sites such as, for example, eBay.com, may be used for hosting options of previously purchased digital content. Predetermined pricing restrictions may determine the minimum starting value and/or incremental bidding value. Alternatively, the seller may specify these values. When the auction is completed, the seller is required to transfer the auction digital music file to an intermediate server system such as, for example, host system 104. The host system 104 may be configured or designed to provide escrow services between the seller of the digital music file and the buyer (i.e., auction winner). The host system 104 may also be configured or designed to handle financial transactions relating to the auction. In one implementation, the auction site and/or escrow site may receive a share of the sale proceeds. Additionally, in at least one implementation, the copyright owner of the digital music file may also receive a share of proceeds from the sale.

In the example of FIG. 3, it is assumed that a consignment technique is used to enable a customer to sell the identified digital music file. Accordingly, once the appropriate music file resale procedures have been initiated, the host system 104 transmits (36) a request to the client system 102 to retrieve the identified music file which is to be offered for resale. In response, the client system 102 transfers (38) (e.g., uploads) the identified music file to the host system 104. Upon completion of the music file transfer, host system 104 may then verify (40) the authenticity and/or integrity of the received music file. One purpose of the integrity check is to verify that the transferred music file has not been corrupted or modified without permission. According to at least one implementation, verification of the authenticity of the transferred music file may be performed using a variety of different techniques. For example, information stored at host system 104, information stored at the ownership authentication system 106 and/or information embedded in the transferred music file (e.g., ownership information) may be used to verify that the music file offered for sale is a legitimately purchased copy and that the seller's customer ID is recorded as being the current owner of that music file.

Assuming that there are no issues with the authenticity and/or integrity of the received music file, the host system 104 may transmit (42) a confirmation message to the client system 102 that the identified music file has been received and approved for resale. Additionally, the host system may provide the client system with updated information which may be used to modify (44) information in the client application data file 102b. Such updated information may include, for example, information relating to the sale or transfer of the identified music file. In at least one embodiment, the client application may use this information, for example, to detect possible copyright law violations (e.g., relating to unauthorized duplicate copies of the identified music file), and/or to prevent a duplicate copies of the identified music file from being played, duplicated and/or transferred. Additionally, according to one implementation, the host system 104 may also notify other client systems in the network (which, for example, have been authorized to play music files associated with the seller's customer ID) of the sale of the identified music file.

Additionally, according to at least one embodiment, once the client application has received confirmation from the host system that the identified music file has been successfully transferred to the host system and approved for resale, the identified music file may be deleted (46) or purged from the client system 102. In an alternate embodiment where an auction technique is used for reselling digital music files, the identified music file may be deleted from the client system after the identified music file has been sold and uploaded to the escrow server. In one implementation, the client application 102a may be configured or designed to manage the deletion of the identified music file, and to report (48) confirmation of the music file deletion operation to the host system (if desired). According to one embodiment, if the client application is unable to confirm deletion of the identified music file on the client system 102, the host system 104 may respond, for example, by canceling the resale of the identified music file and/or transferring the identified music file back to the client system 102.

As illustrated in the embodiment of FIG. 3, the host system 104 may also modify (50) a customer information file associated with the seller's customer ID with updated information relating to the sale of the identified music file by the customer. Additionally, the host system 104 may also register (52) the identified music file and related information (e.g., seller information, song information, pricing information, resale restrictions, encoding format information, etc.) with an on-line digital content resale store that will host the sale of the identified music file. Thereafter, the identified music file may be published for resale.

According to at least one embodiment, the client application 102a may be configured or designed to display information relating to the resale of digital music files which, for example, may be offered from one or more on-line music resale stores. This information may be displayed to on-line customers or visitors who desire to purchase “used” or previously purchased songs/digital music files. According to at least one implementation, the on-line music resale store may offer individuals songs for resale as well as entire albums. In one implementation, the on-line music resale store may be configured or designed to collate digital music file resale information from different sources and/or sellers, and present packaged information to prospective purchasers. For example, the on-line music resale store may offer for resale a “package” of songs (from different sellers) which correspond to a set of songs of a particular album, genre, and/or artist.

FIG. 4 shows flow diagram for illustrating how a customer may purchase a previously purchased digital music file in accordance with a specific embodiment of the present invention. In the example of FIG. 4, it is assumed at (54) that the customer desires to purchase a selected music file (or song copy) from an on-line music resale store. In this example it is also assumed that the on-line music resale store is implemented at the digital content resale server 104b, located at host system 104. In alternate embodiments, one or more on-line music resale stores may be implemented at different servers in the computer network. In one implementation, a customer at client system 102 may submit (56) a request to host system 104 to purchase an identified music file (or song copy) which is offered for resale. In one embodiment, the client application 102a may be used to submit such a request. According to at least one embodiment, the request may include information such as, for example, customer ID, IP address of the client system, a client system ID, song ID, music file ID, etc.

Once the request to purchase an identified music file has been received at the host system 104, the request is processed (58), and a determination is made as to whether there are any restrictions on the sale of the identified music file. According to at least one embodiment of the present invention, a variety of different rules and/or restrictions may be implemented in order to restrict the purchase of previously purchased songs. Such rules/restrictions may be triggered, for example, upon the occurrence of a variety of different conditions. Examples of at least some of the different conditions which may trigger restrictions on the purchase of an identified music file are described below.
1. The identified music file is already being purchased or has already been purchased by another customer.
2. Copyright law violations have been detected in association with the identified music file.
3. The resale rights associated with the identified music file have been used up or expired.
4. Resale of the identified music file would violate resale timing restrictions.
5. Resale of the identified music file would violate copyright laws and/or licensing restrictions.
6. Identified music file is not permitted to be sold to identified Customer ID.

The examples above illustrate some possible conditions which may trigger restrictions on the purchase of the identified music file. However, it will be appreciated that there are a variety of other types of conditions which may trigger restrictions on the purchase previously purchased digital music files.

If it is determined that there are no restrictions on purchase of the identified music file, the host system may then initiate and complete (60) the electronic purchase payment transaction for the identified music file. For example, according to at least one embodiment, the identified music file may be placed into the customer's electronic shopping cart and purchased using conventional electronic commerce transaction techniques. After the host system has verified (62) completion of the payment transaction for the identified music file, the identified music file may then be modified (64) for resale to the purchasing customer. In an alternate embodiment, a new, modified copy of the identified music file may be created for resale to the purchasing customer, and the original copy of the identified music file may be destroyed.

As mentioned previously, different embodiments of the present invention may be implemented in a manner which offers reasonable safeguards to the record companies for helping to preserve their potential profits. One such solution relates to modifying resold digital music files in a manner which results in a degradation of the market value of such files as compared to their new digital music file counterparts.

According to at least one embodiment of the present invention, a variety of different techniques may be used for modifying resold digital music files in a manner which results in a degradation of the market value of such files as compared to their new digital music file counterparts. Examples of at least some of these techniques are described below.
1. Restrictions on the resale rights associated with the identified music file may be imposed. For example, in one implementation, the identified music file may be prohibited from being resold to other customers. Alternatively, time restrictions may be imposed for future resale of the identified music file.
2. Sound quality of the identified music file may be modified. For example, in one implementation, the sound quality of the identified music file may be degraded in order to lower its market value.
3. Identified music file may be appended and/or prepended with additional content. For example, in at least one embodiment, additional audio content may be prepended to the identified music file. When the music file is subsequently played on the client system, the additional audio content will be played to the user or customer. In one implementation, the audio content may include advertising content, which may allow for additional revenue to be generated from the resale of the identified music file. In one implementation, the identified music file may be modified in a manner which permits the additional audio content to be played only a predetermined number of times when the identified music file is played. For example, the identified music file may be modified in a manner which permits the additional audio content to be played the first time that the identified music file is played on the client system, and not played thereafter.
4. Encoding format of identified music file may be modified. For example, in one implementation, new copies of digital music files may be encoded using one format, and resale copies of digital music files may be encoded using another format.
5. Restrictions on the copying rights associated with the identified music file may be imposed. For example, in one implementation, digital music files which have been repurchased may be prohibited from being copied, duplicated and/or burned to CD.

The examples above illustrate some possible techniques which may be used for modifying resold digital music files in a manner which results in a degradation of the market value of such files as compared to their new digital music file counterparts. However, it will be appreciated that other techniques commonly known to one having ordinary skill in the art may also be used.

Additionally, it will be appreciated that, according to alternate embodiments of the present invention, other techniques may be used for providing safeguards to record companies for helping to preserve their potential profits. For example, according to at least one implementation, the customer attempting to purchase a previously purchased digital music file may first have to satisfy one or more conditions before the purchase is allowed to be completed. For example, in one implementation, the purchasing customer may be required to listen and/or view an advertisement or other content before being allowed to purchase the identified music file. Customers not wishing to comply with such conditions may prefer to purchase a new copy of the selected song at a higher price.

Returning to FIG. 4, the modification of the identified music file for resale to the customer may also include other modifications of the identified music file such as, for example, modifying the ownership information, modifying information relating to restrictions on use, sale, or transfer; and/or modifying other information or metadata associated with the identified music file. Additionally, according to at least one implementation, the identified music file may be re-encrypted using a unique encryption key associated with the purchasing customer's customer ID.

As shown at (66), the host system may send information relating to the purchase of the identified music file may to the ownership authentication system 106. In one implementation, such information may include, for example, the song ID, music file ID, the customer ID, information relating to the system which sold the song (e.g., host system ID), time of purchase, date of purchase, amount of purchase, etc. The ownership authentication system may then process (68) and store at least a portion of the identified music file purchase information, in a local database and/or a centralized database.

As shown at (70) the ownership authentication system may transmit acknowledgment information back to host system 104. The host system may modify (72) its database to include information relating to the sale of the identified music file.

As shown at (74), the host system 104 transfers the modified, encrypted copy of the purchased identified music file and other information to the client system 102.

According to one embodiment, such other information may include, for example, information relating to the digital music purchased by the customer such as, for example, song ID; music file ID; customer ID; encryption/decryption key(s); restrictions on sale, transfer, duplication; etc. Once the transfer is complete, the client system may modify (76) one or more client application data file(s) to include at least a portion of additional information received.

As shown at (78), the host system 104 may reports the resale of the identified music file to appropriate entities/systems. For example, in one implementation, resale of the identified music files may be reported to music licensing agencies such as, for example, BMI and ASCAP. Additionally, the host system may also perform (80) any necessary financial transactions relating to the sale of the identified music file. For example, according to different embodiments, such financial transactions may include:
1. Paying a commission (or fee) to the on-line music store for the sale of the identified music file;
2. Paying a royalty, fee, and/or portion of the sales price to the copyright owner of the identified music file; and/or
3. Paying the balance or residual amount of the sales price to the seller of the identified music file.

It will be appreciated that one of the benefits of the technique of the present invention is its ability to be easily integrated with existing technology.

Generally, the on-line digital content resale techniques of the present invention may be implemented on software and/or hardware. For example, they can be implemented in an operating system kernel, in a separate user process, in a library package bound into network applications, on a specially constructed machine, or on a network interface card. In a specific embodiment of this invention, the technique of the present invention is implemented in software such as an operating system or in an application running on an operating system.

A software or software/hardware hybrid implementation of the on-line digital content resale techniques of this invention may be implemented on a general-purpose programmable machine selectively activated or reconfigured by a computer program stored in memory. Such programmable machine may be a network device designed to handle network traffic, such as, for example, a router or a switch. Such network devices may have multiple network interfaces including frame relay and ISDN interfaces, for example. A general architecture for some of these machines will appear from the description given below. In an alternative embodiment, the on-line digital content resale techniques of this invention may be implemented on a general-purpose network host machine such as a personal computer or workstation. Further, the invention may be at least partially implemented on a card (e.g., an interface card) for a network device or a general-purpose computing device.

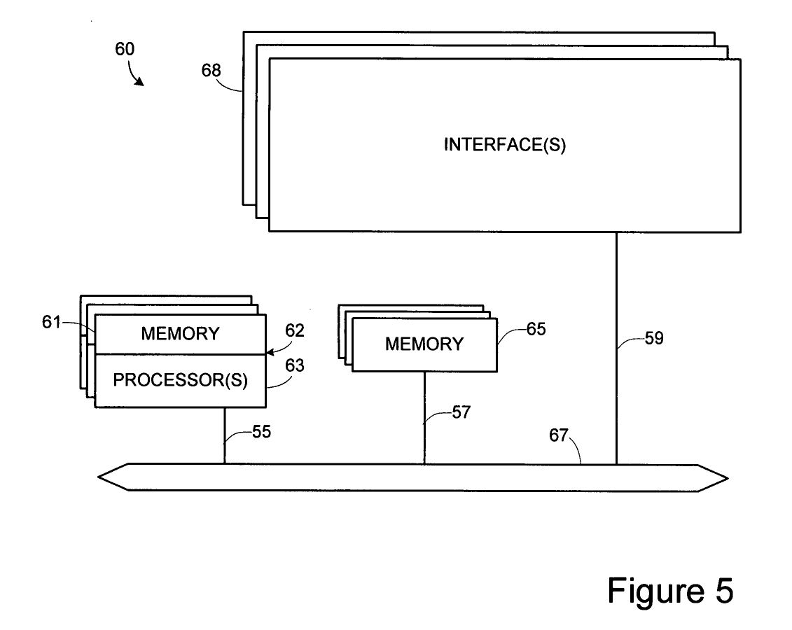

Referring now to FIG. 5, a network device 60 suitable for implementing the on-line digital content resale techniques of the present invention includes a master central processing unit (CPU) 62, interfaces 68, and a bus 67 (e.g., a PCI bus). When acting under the control of appropriate software or firmware, the CPU 62 may be responsible for implementing specific functions associated with the functions of a desired network device. For example, when configured as a host device, the CPU 62 may be responsible for analyzing packets, encapsulating packets, forwarding packets to appropriate network devices, processing HTTP requests, etc. The CPU 62 preferably accomplishes all these functions under the control of software including an operating system (e.g. Windows NT), and any appropriate applications software.

CPU 62 may include one or more processors 63 such as a processor from the Motorola family of microprocessors or the MIPS family of microprocessors. In an alternative embodiment, processor 63 is specially designed hardware for controlling the operations of network device 60. In a specific embodiment, a memory 61 (such as non-volatile RAM and/or ROM) also forms part of CPU 62. However, there are many different ways in which memory could be coupled to the system. Memory block 61 may be used for a variety of purposes such as, for example, caching and/or storing data, programming instructions, etc.

The interfaces 68 are typically provided as interface cards (sometimes referred to as “line cards”). Generally, they control the sending and receiving of data packets over the network and sometimes support other peripherals used with the network device 60. Among the interfaces that may be provided are Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor 62 to efficiently perform routing computations, network diagnostics, security functions, etc.

Although the system shown in FIG. 5 illustrates one specific network device of the present invention, it is by no means the only network device architecture on which the present invention can be implemented. For example, an architecture having a single processor that handles communications as well as routing computations, etc. is often used. Further, other types of interfaces and media could also be used with the network device.

Regardless of network device's configuration, it may employ one or more memories or memory modules (such as, for example, memory block 65) configured to store data, program instructions for the general-purpose network operations and/or other information relating to the functionality of the on-line digital content resale techniques described herein. The program instructions may control the operation of an operating system and/or one or more applications, for example. The memory or memories may also be configured to store data structures, customer information, digital content information, electronic commerce information, and/or other specific non-program information described herein.

Because such information and program instructions may be employed to implement the systems/methods described herein, the present invention relates to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). The invention may also be embodied in a carrier wave traveling over an appropriate medium such as airwaves, optical lines, electric lines, etc. Examples of program instructions include both machine code, such as produced by a compiler, and files containing higher level code that may be executed by the computer using an interpreter.

Although several preferred embodiments of this invention have been described in detail herein with reference to the accompanying drawings, it is to be understood that the invention is not limited to these precise embodiments, and that various changes and modifications may be effected therein by one skilled in the art without departing from the scope of spirit of the invention as defined in the appended claims.

1-35. (canceled)

36. A method for facilitating resale of digital content purchased via an electronic commerce transaction, the method comprising:
receiving a first portion of information relating to a sale of a first copy of a digital file to a first customer, wherein the digital file includes digital content, and wherein the first portion of information includes ownership information which identifies the first customer as the owner of the first copy;
creating a first database record relating to the first copy, wherein the first database record includes ownership information which identifies the first customer as the owner of the first copy;
receiving a second portion of information relating to a resale of the first copy to a second customer, wherein the second portion of information includes ownership information which identifies the second customer as the owner of the first copy;
modifying the first database record to include ownership information which identifies the second customer as the owner of the first copy.

37. A method for facilitating resale of digital content purchased via an electronic commerce transaction, the method comprising:
receiving a request from a first customer to purchase a copy of a digital file which includes digital content;
generating a first copy of the requested digital file, wherein the first copy includes ownership information identifying the first customer as the owner of the first copy;
receiving a request to transfer ownership of the first copy to a second customer; and
generating a second copy of the requested digital file, wherein the second copy includes ownership information identifying the second customer as the owner of the second copy.

38. The method of claim 37 further comprising:
associating a first globally unique identifier with the first copy; and
associating the first globally unique identifier with the second copy.

39. A method for facilitating resale of digital content purchased via an electronic commerce transaction, the method comprising:
receiving a request from a first customer to purchase a copy of a digital file which includes digital content;
generating a first copy of the requested digital file, wherein the first copy includes ownership information identifying the first customer as the owner of the first copy;
receiving a request to resell the first copy to a second customer;
determining whether the first copy is allowed to be resold to the second customer; and
allowing resale of the first copy to the second customer in response to a determination that the first copy is allowed to be resold to the second customer.

40. The method of claim 39 further comprising prohibiting the resale of the first copy to the second customer in response to detecting an occurrence of a first condition.

41. The method of claim 39 further comprising prohibiting the resale of the first copy to the second customer if it is determined that resale rights associated with the first copy have been used up or expired.

42. The method of claim 39 further comprising prohibiting the resale of the first copy to the second customer if it is determined that resale of the first copy would violate resale timing restrictions.

43. The method of claim 39 further comprising prohibiting the resale of the first copy to the second customer if it is determined that resale of the first copy would violate at least one restriction associated with the first copy.

44. The method of claim 39 further comprising prohibiting the resale of the first copy to the second customer if it is determined that there is no purchase record of the first copy associated with the first customer.

45. The method of claim 39 further comprising prohibiting the resale of the first copy to the second customer if it is determined that the first copy has been altered or modified.

46. The method of claim 39 further comprising prohibiting the resale of the first copy to the second customer if it is determined that resale of the first copy would violate maximum authorized number of copies of the digital file authorized for resale.

47. The method of claim 39 further comprising prohibiting the resale of the first copy to the second customer if it is determined that resale of the first copy would violate pricing restrictions.

48. The method of claim 39 further comprising paying a commission or fee to an on-line music store which transacted the resale of the first copy.

49. The method of claim 39 further comprising paying a royalty or fee to the copyright owner of the first copy in response to a resale of the fist copy to the second customer.

50. The method of claim 39 further comprising paying a balance or residual amount of the resale price to the seller of the first copy.

51. The method of claim 39 further comprising:
generating a modified copy of the first file;
the modified copy being generated in a manner which results in a relatively lower market value of the modified copy as compared to the market value of the first copy; and
performing resale of the first file to the second customer by providing the modified copy to the second customer.

52. The method of claim 51 wherein the modified copy of the first file includes restrictions on the resale rights associated with the first copy.

53. The method of claim 51 wherein the modified copy of the first file includes additional content not included in the first file.

54. The method of claim 51 wherein the modified copy of the first file includes restrictions on the copying rights associated with the first copy.
